(19) United States
(12) Patent Application Publication
(10) Pub. No.: US 2025/0209458 A1
(43) Pub. Date: Jun. 26, 2025

(54) SECRET CODE SYSTEM FOR CORRESPONDENCE IDENTITY VERIFICATION

(71) Applicant: The PNC Financial Services Group, Inc., Pittsburgh, PA (US)

(72) Inventor: Robert E. Porco, New Kensington, PA (US)

(21) Appl. No.: 18/391,939

(22) Filed: Dec. 21, 2023

(51) Int. Cl. G06Q 20/40; G06Q 20/32; G06Q 20/38; H04L 9/40

(52) U.S. Cl. CPC G06Q 20/4014; G06Q 20/3274; G06Q 20/3278; G06Q 20/385; H04L 63/083

(57) ABSTRACT

Correspondence identity verification system comprises correspondence generation means for generating a first correspondence to be sent from a financial institution to a first account holder. The first correspondence comprises a first secret code, where the first secret code signifies a first identifying characteristic of the first correspondence; where the financial institution is configured to identify the first correspondence based at least in part on the first secret code received from the first account holder. Correspondence generation means is further for generating a second correspondence sent from the financial institution to the first account holder, where the second correspondence comprises a second secret code that signifies a second identifying characteristic of the second correspondence, and where the financial institution is configured to identify the second correspondence based at least in part on the second secret code received from the first account holder.

### BACKGROUND

Individuals all over the world are targeted with fraudulent schemes by scammers in an attempt to expose an individual's personal information. Scammers can then use such personal information to gain access to an individual's account, such as a bank account, and steal the account's contents, such as money, for example. Given the complexity and seeming authenticity of recent fraudulent schemes, scammers are increasingly obtaining an individual's personal information from the individual himself.

Fraudulent mass mailing campaigns are becoming more popular as a means to gain access to an individual's bank account information. Such mailing campaigns involve sending correspondence to an account holder of a financial institution that appears to be sent from and/or on behalf of the financial institution. The correspondence may include various features representative of the financial institution such as, for example, the financial institution's logo, color and/or font scheme, contact names, and/or other representative indicia. The correspondence typically includes language suggestive of a problem with the account holder's one or more accounts and is meant to solicit a response from the account holder. The contact information, whether it be an email address and/or a telephone number, for example, is often not associated with the financial institution—but rather, with the scammers. As such, should the account holder decide to inquire about the correspondence using the provided contact information, the account holder is unknowingly at risk of exposing sensitive, personal information to a scammer.

Should the account holder decide to contact the financial institution through the financial institution's appropriate contact information, the account holder is likely to experience states of frustration and/or confusion as the financial institution will be unaware of the correspondence to which the account holder is referring. An additional consequence of the fraudulent mailing campaign is the burdening of the financial institution's customer support resources.

### SUMMARY

In one general aspect, the present invention involves, in various embodiments, using a secret code for correspondence between enterprise (such as business, such as a financial institution) and a customer of the enterprise. The secret code, for example, when communicated by the customer to a customer service representative in a follow-up communication between the customer and the customer service representative, can allow the customer service representative to, using the code, determine the nature of the prior correspondence sent to the customer. Both the customer and the customer service representative can use the secret code to validate the identity of the other party. The code can also aid in identifying fraudulent schemes involving correspondence sent to the customer from a party other than the enterprise.

In that connection, embodiments of the present invention are directed to, in various embodiments, a correspondence identity verification system that comprises correspondence generation means for generating a first correspondence to be sent from a financial institution to a first account holder. The correspondence can be, for example, an email, a hardcopy letter, or an automated phone call. The first correspondence can comprise a first secret code, where the first secret code signifies a first identifying characteristic of the first correspondence, and where the financial institution is configured to identify the first correspondence based at least in part on the first secret code received from the first account holder. The correspondence generation means is further for generating a second correspondence sent from the financial institution to the first account holder, where the second correspondence comprises a second secret code, where the second secret code signifies a second identifying characteristic of the second correspondence, and where the financial institution is configured to identify the second correspondence based at least in part on the second secret code received from the first account holder.

This solution, in various embodiments, allows both account holders and financial institutions to identify whether correspondence received by account holders was in fact sent by a particular financial institution. This solution can also provide a customer support department within the financial institution an ability to efficiently identify a specific correspondence referred to by an inquiring account holder. These and other advantages that can be realized through embodiments of the present invention will be apparent from the description that follows.

### BRIEF DESCRIPTION OF THE FIGURES

Various embodiments of the present invention are described herein by way of example in connection with the following figures.

FIG. 1 is a schematic representing various communication pathways extending between a bank account holder, a financial institution, and a fraudulent entity.

FIG. 2 is a schematic representing a correspondence having a secret code displayed thereon.

FIG. 3 is a schematic representing a first correspondence having a first secret code displayed thereon, a second correspondence having a second secret code displayed thereon, and a third correspondence having a third secret code displayed thereon.

FIG. 4 is a schematic representing a correspondence identity verification system including a correspondence generation means.

FIG. 5 is a schematic representing a plurality of databases of information stored by a financial institution.

Corresponding reference characters indicate corresponding parts throughout the several views. The exemplifications set out herein illustrate various disclosed embodiments, is one form, and such exemplifications are not to be construed as limiting the scope thereof in any manner.

### DETAILED DESCRIPTION

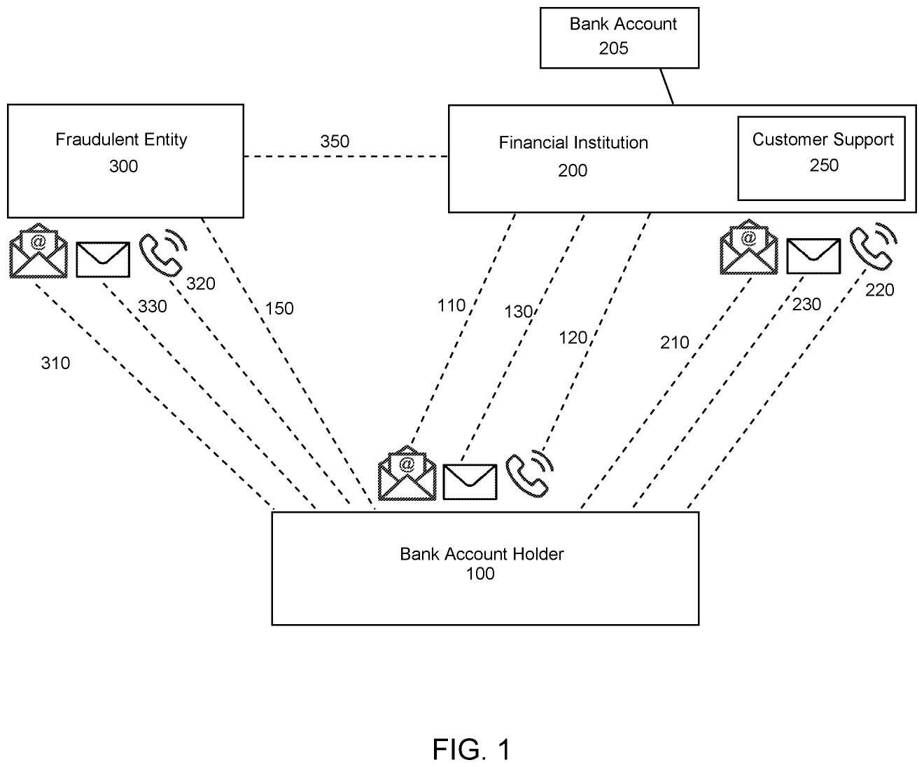

Various embodiments of the present invention are described herein by way of example in the context of different scenarios. The first scenario is one that provides shortened customer wait times and increased efficiency. An individual or a corporation is a custodian 100, or owner, of a bank account held at a particular financial institution 200. FIG. 1 illustrates various communication pathways between the account holder 100 and the financial institution 200 during a routine course of business. The financial institution 200 sends various correspondence to the account holder 100 during a lifetime of the bank account 205 to notify the account holder 100 of information relating to the bank account 205. Such information includes a status of the account, a suspicious activity related to the account, and/or a request for updated bibliographic information of the account holder, for example. Such correspondence can be delivered to the account holder 100 by way of an email 110, an audio and/or text phone message 120, and/or a physical letter 130.

All correspondence sent to an account holder 100 by the financial institution 200 is logged, or otherwise stored, by the financial institution 200 in a file relating to the bank account 205 and/or the owner 100 of the bank account. As such, if the owner 100 of the bank account decides to contact the financial institution 200 regarding a received correspondence, the financial institution 200 can identify the particular correspondence and/or have an informed, productive conversation about the contents of the particular correspondence, for example. More specifically, the owner 100 of the bank account can contact a customer service department 250 of the financial institution by way of an email 110, an audio and/or text phone message 120, and/or a physical letter 130, for example. Such productive conversations can increase the confidence the account holder 100 has in the financial institution 200 and/or foster continued business relationships.

While the financial institution 200 maintains records of all correspondence sent during the lifetime of the bank account 205, it can be time consuming, or otherwise difficult, for a customer service representative of the financial institution to identify the particular correspondence to which an inquiring account holder is referring. In an effort to help the customer service representative quickly and/or accurately identify the correspondence being referred to by the account holder 100, various embodiments of the present invention can use a secret code system for organizing and/or identifying communications from the financial institution to the account holder. Such a secret code system is designed to include a randomized and/or secret code, or series of characters, on all correspondence communicated to the account holder 100 from the financial institution 200.

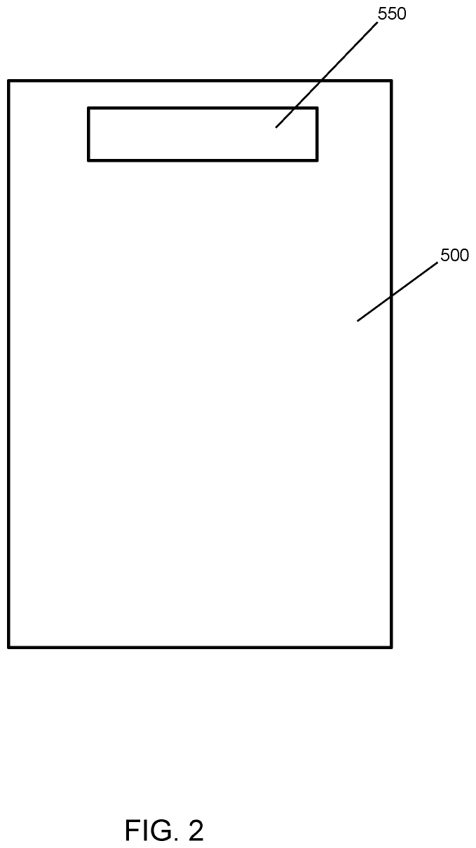

Referring now to FIG. 2, a correspondence 500 sent by the financial institution 200 to an account holder 100 is depicted. As described above, such correspondence 500 can be in the form of a physical letter 230, an email message 210, an audio and/or text phone message 220, or any other suitable form of communication. A secret code 550 is visibly marked on the correspondence 500. In instances where the correspondence takes the form of an audio call 220, the code 550 is spoken, or otherwise verbally communicated. Thus, in various embodiments, the financial institution 200 includes a printer system with printers for printing the code on physical letters; a computer system programmed to generate emails for account holders of the financial institution with the appropriate secret code in email; and/or an automated calling system, with text-to-speech functionality, to enunciate the appropriate secret code in a call to an account holder.

Such a code 550 can be of any desired length and can include any numerical character, alphanumerical character, special character, or any combination thereof. The code 550 can be randomly generated by a computer, assigned by the financial institution 200, and/or the code 550 can be selected in part and/or in full by the account holder 100. In instances where the code 550 is selected in part and/or in full by the account holder 100, the code 550 can share similarities to a Personal Identification Number (PIN), for example. In instances where the code 550 is selected in part by the account holder 100, an additional portion of the code 550 is randomly generated, or otherwise selected, by the financial institution 200. In any event, all codes 550 are intended to remain private and only shared on verified communication paths between the account holder 100 and the financial institution 200.

The financial institution 200 can store all of the generated codes 550 and their associated meanings in an encrypted, or otherwise secured, database. In various instances, the secret codes and their associated affiliations are configured to be stored in a Nacha-compliant database. For example, the codes and their associated affiliations can be encrypted; commercially reasonable encryption technology can be utilized for all transmission of data to and/or from the system via an unsecured network (e.g. the Internet). In various aspects, the codes and their associated affiliations are stored in the compliant database in an electronic format in which such data is unreadable at rest. The data can be encrypted with at least 128-bit encryption protocols and, in other instances, at least 256-bit encryption. For example, 128-bit or 256-bit advanced encryption system (AES), SSL or RSA encryption could be employed for the database(s) storing the codes and their associated affiliations. Implementations of the processes disclosed herein provide improvements by way of decentralized computing, data incorruptibility, transparency and redundancy, or secure authentication.

The database can be stored locally on servers internal to the financial institution or remote to the financial institution. Alternatively or additionally, the database can be stored in a cloud-based storage solution. Any suitable storage method is envisioned that reliably stores the information while allowing an authorized user from the financial institution to readily access the information.

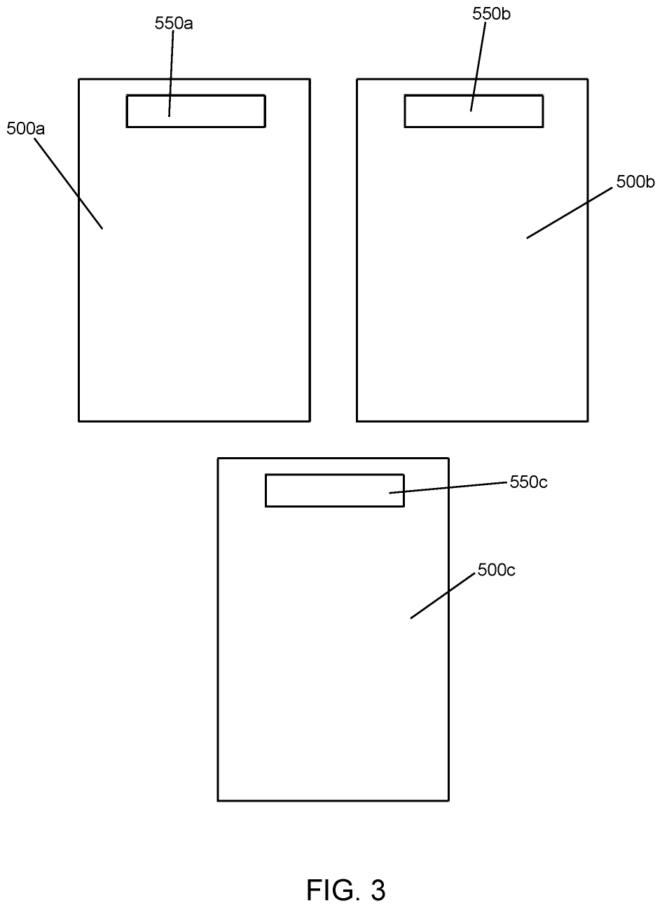

As shown in FIG. 3, different codes 550a, 550b, 550c can be used to label, and subsequently identify, different correspondence sent by the financial institution 200 to a single account holder 100, or relating to a single bank account 205. For example, a first correspondence 500a is marked with a first code 550a, a second correspondence 500b is marked with a second code 550b, and a third correspondence 500c is marked with a third code 550c.

For example, the first correspondence 500a is an account statement disclosing a balance activity of the bank account 205. The second correspondence 500b is an alert that a fraudulent, or otherwise suspicious, activity was detected in reference to the bank account 205. The third correspondence 500c is a request for updated bibliographic information of the account holder 100. Stated another way, the first correspondence 500a is a first type of correspondence, the second correspondence 500b is a second type of correspondence, and the third correspondence 500c is a third type of correspondence. The first, second, and third types of correspondence are all different from one another. The financial institution 200 can selectively organize all types of correspondence into designated groups that each are assigned and labeled with a particular code 550. Alternatively, each type of correspondence can be assigned a unique, particular code 550.

Additionally or alternatively, the first correspondence 500a is sent at a first time, the second correspondence 500b is sent at a second time, and the third correspondence 500c is sent at a third time. The first time, the second time, and the third time are all different from one another. For example, a time is considered different if the correspondence was sent on a different day, during a different statement period, or during any other suitable division of time where a difference is readily discernable. The financial institution 200 can selectively identify a desired time period duration and label all correspondence sent during the same time period with the same code 550. In instances where a temporal difference is discernable between when a first correspondence 500a is sent and when a second correspondence 500b is sent, a unique, particular code 550 is assigned to each correspondence 500a, 500b.

Additionally or alternatively, the first correspondence 500a is sent as an email message, the second correspondence 500b is sent as an audio phone message, and the third correspondence 500c is sent as a physical letter. Stated another way, the forms of communication are different between the first correspondence 500a, the second correspondence 500b, and the third correspondence 500c. As such, a unique, particular code 550 is assigned to each correspondence 500a, 500b, 500c. In instances where multiple correspondence is sent through a particular form of communication, such correspondence share a common code 550.

As depicted in FIG. 3, the first, second and third codes 550a, 550b, 550c are all different from one another. Codes 550 can be different from one another in various manners. For example, the first code 550a can be a first length of characters, and the second code 550b can be a second length of characters—the first length being different than the second length. Additionally or alternatively, the first code 550a can be a first combination of numeric, alphanumeric, and/or special characters, and the second code 550b can be a second combination of numeric, alphanumeric, and/or special characters—the first combination being different than the second combination. In lieu of, or in addition to, numeric, alphanumeric, and/or special characters, a code may comprise, for example, a QR code and/or a NFC chip (or tag). In the case of a QR code, the QR code could be printed on paper correspondence or placed as an image in an email. The recipient could scan the QR code with a QR code scanner (e.g., a mobile device with a camera). The mobile device can resolve the QR code to display the code for the recipient (e.g., a code with numeric, alphanumeric, and/or special characters). The QR code may point to a URL from which the mobile device receives the code for display to the recipient. In the case of a NFC chip, the NFC chip could be placed as a sticker on paper correspondence or it could be embedded into the paper correspondence. The recipient can scan the NFC chip with a NFC reader, which could be part of the recipient's smartphone, which displays the code for the recipient on the NFC reader (e.g., the recipient's smartphone).

Upon receiving an inquiry from the account holder 100, a representative from the customer service department 250 can inquire as to whether a particular correspondence 500 is labeled with a code 550. If the account holder 100 is able to locate a code, the representative can ask the account holder 100 to specify the code 550. The representative can then utilize the identified code 550 to efficiently and accurately determine the specific correspondence 500 to which the account holder 100 is referring. Such efficient identification can minimize, or otherwise reduce, the time spent filtering through all of the correspondence sent to the account holder while trying to accurately identify which correspondence is talking about. The reduction in time spent on at the beginning of customer inquiries can alleviate a burden placed on the customer service department 250.

While the codes have been described as being unique to both a particular account holder and a particular correspondence, it is envisioned that the codes 550 can be uniform for all account holders and/or for all particular correspondence. Stated another way, a code 550 can be specific to each particular account holder; alternatively, the code 550 can be used universally across all account holders to identify, or otherwise refer to, a particular correspondence.

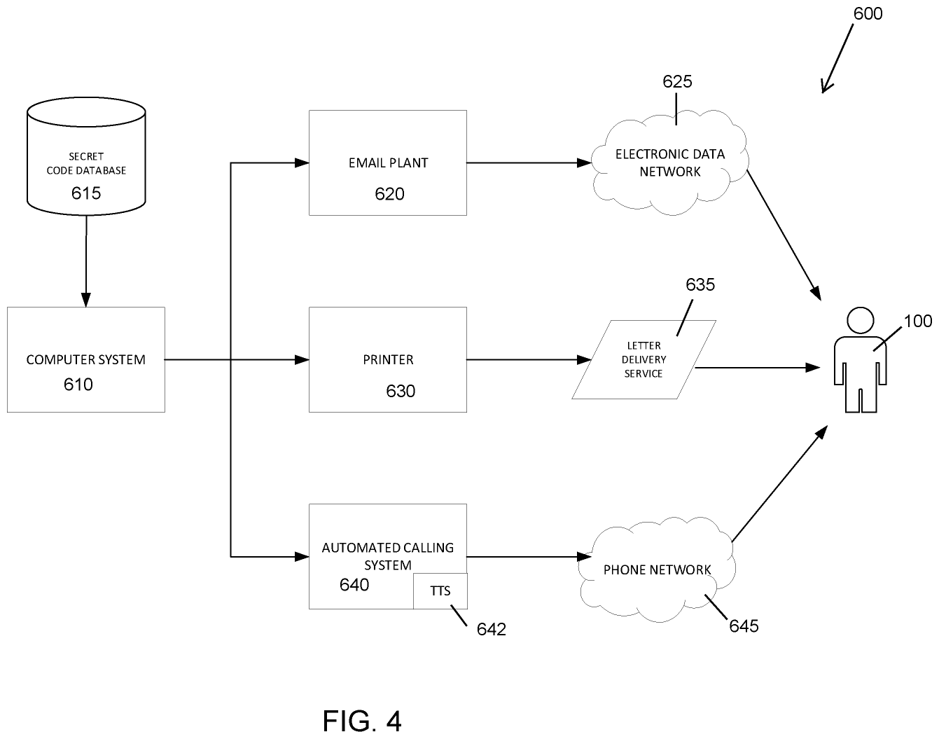

Referring now to FIG. 4, a correspondence identity verification system 600 is depicted. The system 600 includes a computer system 610 and a correspondence generation means 620, 630, 640 to generate various types of correspondence to be communicated through various mediums to an account holder 100. The correspondence generation means is further configured to generate and display (or otherwise include) a secret code, such as code 550, on or in the correspondence. A secret code database 615 is in communication with the computer system 610 and stores all of the generated secret codes and their associated correspondence(s). The secret code database 615 is intended to only be accessed by an authorized user, such as a verified representative of the financial institution, for example. The secret code database 615 may store a table that associates, such as in a row of the table, for each secret code information such as: the type of correspondence it was included with; a date stamp for when the correspondence was transmitted; the intended recipient (e.g., an account holder); the means of transmission (e.g., email, physical letter, phone call); and/or the address to which the correspondence was transmitted (e.g., email address, mailing address, phone number).

The correspondence generation means can include a computer-based email plant 620. The computer-based email plant 620 may be implemented as one or more computer servers that handle an email protocol for the financial institution associated with the computer system 610 The email plant 620 may facilitate the sending and receiving of correspondence via an electronic data network 625, such as the Internet. In various instances, the secret code can be displayed as an image in an email correspondence by embedding the image of the secret code in an HTML message body. For example, the secret code can be displayed as an image in the body of the email correspondence by having the correspondence generation means embed a base64 image in HTML

Alternatively or additionally, the correspondence generation means includes a printer 630 that prints a correspondence in the form of text or pictures onto a physical paper, for example. In such instances, the correspondence is communicated, or otherwise delivered, to the account holder 100 by way of a letter delivery service 635. The letter delivery service 635 includes services such as the United States Postal Service, for example.

Alternatively or additionally, the correspondence generation means includes an automated calling system 640 with a text-to-speech (TTS) 642 engine. The TTS engine 642 can convert text (generated by the computer system 610 or the automated calling system 640, e.g., the script of the correspondence including the associated secret code for the audio phone message) to speech to play in the phone call. The generated audio phone message is then communicated, or otherwise delivered, to the account holder 100 by way of a phone network 645, such as a POTS (plain old telephone service) network, an ISDN network, a cellular network, a mobile network, or the Internet (e.g. for a VoIP call), for example.

The second scenario shows how the secret code can be used for identity verification purposes. As discussed above, a code 550 is generated and labeled on a correspondence 500 sent from the financial institution 200 to the account holder 100. While the code 550 can be used by the customer service department 250 to increase efficiency in handling account holder inquiries, the code 550 can additionally or alternatively be used to provide confidence and/or security to both the financial institution 200 and the account holder 100. Stated another way, an exchange of the secret code 550 in a communication exchange between the account holder 100 and the customer service representative is a form of identity verification for both the account holder 100 (of the financial institution) and the financial institution (of the account holder).

More specifically, a representative from the financial institution 200 can be confident he/she is communicating with the account holder 100 if the account holder 100 is able to at least provide the specific code 550 marked on the correspondence 500. Fraudulent schemes involving an “account holder” 350 contacting the financial institution 200 in an attempt to gather sensitive information can be thwarted, or otherwise prevented, by inquiring the “account holder” for the secret code 550. Similarly, the account holder 100 can be confident he/she is communicating with a verified representative from the financial institution 200 if the representative is able to at least provide the secret code 550 marked on the correspondence 500. Fraudulent schemes involving an account holder receiving a phone call, or other inquiry, from “the bank” can be thwarted, or otherwise prevented, by giving the account holder 100 the ability to inquire for the secret code 550, as only the account holder 100 and the true financial institution 200 should be in possession of the code 550.

In a third scenario, embodiments of the present invention can mitigate risk from a fraudulent entity mailing a correspondence to the account holder. Referring back to FIG. 1, various communication pathways between the account holder 100, the financial institution 200, and a fraudulent entity 300 are further illustrated. More specifically, in an effort to gain valuable information relating to the custodian's bank account, for example, the fraudulent entity 300 sends a correspondence to the bank account holder 100 impersonating the financial institution 200. Such correspondence can be communicated to the bank account holder 100 via an email 310, an audio and/or text phone message 320, and/or a physical letter 330, for example. Due, in part to recent technology and convincing tactics, the fraudulent entity 300 is able to successfully convince the bank account holder 100 that such correspondence is actually being sent by the financial institution 200. Oftentimes, the account holder 100 does not even question the source of the correspondence and unknowingly communicates 150 valuable, identifying, and/or otherwise sensitive information to the fraudulent entity 300. The fraudulent entity 300 can then use this information to gain access to the bank account 205, to profit off of the harvested information, and/or to gain access to other accounts held by the account holder 100.

Alternatively and/or additionally, the account holder 100 can contact the financial institution 200 directly regarding any received correspondence. More specifically, the account holder 100 can contact a customer support department 250 of the financial institution to discuss the content of such received correspondence. The account holder 100 can contact the customer support department 250 by way of an email 110, a phone call 120, and/or a physical letter 130, for example.

Given that any correspondence 310, 320, 330 sent by the fraudulent entity 300 was not actually sent by the financial institution 200, no record of such correspondence will be noted in any file at the financial institution. As such, the customer support department 250 will be unable to assist the account holder 100 with any inquiries leaving the account holder 100 frustrated and/or concerned, for example. In any event, the inability of the customer support department 250 to assist the account holder 100 does little to foster the account holder's confidence in the financial institution and/or impairs the reputation of the financial institution. Such negative impressions can cause the financial institution to lose business, as the account holder will likely choose to move his/her bank account to an alternate financial institution.

The presence of the secret code 550 on each correspondence from the true financial institution 200 provides another layer of protection to its account holders. While such correspondence contains other identifying aspects of the financial institution 200, such as a logo, use of particular colors, etc., such features are readily reproducible. By implementing the secret code system, a customer service representative from the financial institution 200 can instantaneously alert an account holder 100 that a received correspondence is fraudulent by identifying an absence of the correct, and/or any, secret code 550 on the correspondence 500. Similarly, an informed account holder 100 is able to instantaneously identify and disregard a correspondence as fraudulent by identifying an absence of the correct, and/or any, secret code 550 on the correspondence 500. Such timely identification serves to remove, or otherwise decrease, a burden placed on the customer service department 200 while also improving account holder perceptions of the financial institution's security, for example.

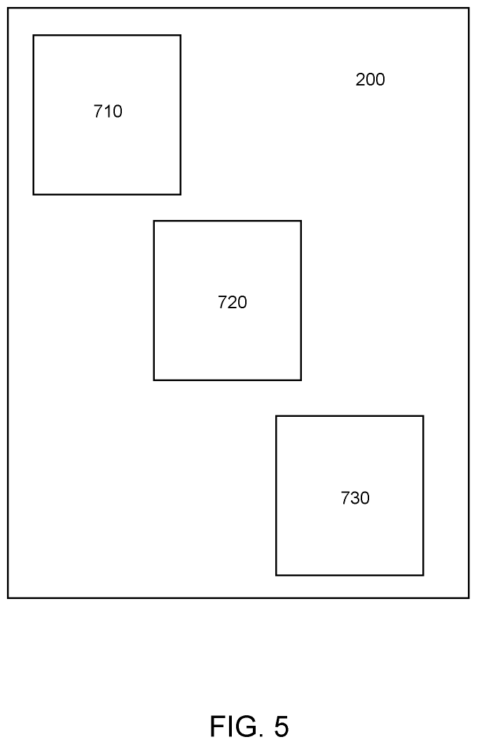

As shown in FIG. 5, a plurality of databases containing information associated with particular bank accounts is stored and/or accessible within the financial institution 200. The plurality of databases includes a first database 710 storing account information associated with particular bank accounts. Such account information can include, for example, account numbers and/or bibliographic information of account holders, for example. A second database 720 stores transaction information associated with particular bank accounts. Such transaction information can include a ledger, for example, of all transactions associated with a particular bank account, including, for example, a balance of the bank account. A third database 730 stores customer support information associated with particular bank accounts. Such customer support information includes the secret codes associated with particular correspondence sent to the account holders of bank accounts. While three exemplary databases are shown and described herein, any suitable number and/or combination of databases is envisioned for the financial institution to group information and/or control internal access to information.

In various embodiments, the databases 710, 720, 730 could be part of an on-premises database management system. For example, the databases 710, 720, 730 could be connected, via a database management system, via a LAN or WAN network of the financial institution. The databases 710, 720, 730 could also be part of a distributed storage system, such as a Hadoop cluster. Still further, one or more of the databases 710, 720, 730, or portions thereof, may be stored off-site of the financial institution, such as in cloud storage.

In various instances, only a particular employee, or group of employees, of the financial institution has access to a particular database. For example, the financial institution may selectively grant permission for one or more of its employees to access the contents of one or more databases. Such access can be granted and/or approved using an employee's login information and/or IP address, for example. Stated another way, access to each particular database can be granted, restricted, or denied using employee authentication credentials. For example, a first employee may be granted access to the contents of the first database 710 storing account information; however, the first employee does not have access to the contents of the second database 720 and/or the third database 730. The financial institution may selectively grant permission for a second employee to access the contents of the second database 720 and the third database 730, but not the first database 710, for example.

As described above, the third database 730 includes the secret codes communicated to the account holders and their associated correspondences. In various instances, only customer service representatives of the financial institution and/or their manager(s) can access the contents of the third database 730. Stated another way, non-customer support personnel cannot access the secret codes stored in the third database 730. Non-customer support personnel include employees and/or contractors of the financial institution who do not interact with customers, such as technical administrators, for example. Walling such non-client interfacing employees from the secret codes minimizes, or otherwise prevents, the secret codes from becoming compromised.

In one general aspect, therefore, the present invention is directed to correspondence identity verification systems and methods. In various embodiments, the correspondence identity verification system comprises correspondence generation means for generating a first correspondence to be sent from a financial institution to a first account holder. The first correspondence comprises a first secret code, where the first secret code signifies a first identifying characteristic of the first correspondence; where the financial institution is configured to identify the first correspondence based at least in part on the first secret code received from the first account holder. The correspondence generation means is further for generating a second correspondence sent from the financial institution to the first account holder, where the second correspondence comprises a second secret code that signifies a second identifying characteristic of the second correspondence, and where the financial institution is configured to identify the second correspondence based at least in part on the second secret code received from the first account holder.

A method according to various embodiments comprises the step of generating, by the financial institution, a first correspondence using a correspondence generation means of the financial institution, where the correspondence generation means generates a first secret code based at least in part on a first characteristic of the first correspondence, and where the first secret code is included in the first correspondence. The method also comprises the step of storing the first secret code in a code database of the financial institution, such that the code database associates the first correspondence to the first secret code. The method also comprises the step of transmitting the first correspondence to the first account holder of the financial institution. The method also comprises the step of, after transmitting the first correspondence, receiving, by the financial institution, a first inquiry from the first account holder regarding the first correspondence, where receiving the first inquiry comprises receiving, by the financial institution, as part of the first inquiry, the first secret code included in the first correspondence from the first account holder. And the method further comprises the step of, after receiving the first secret code from the first account holder, looking up, by the financial institution, the first secret code in the code database to identify the first correspondence associated with the first secret code.

In various implementations, the correspondence identity verification system further comprises a code database in communication with the correspondence generation means, where the code data base stores the first secret code and the second secret code. Also, in various embodiments, only the financial institution has access to the code database. Also, access to the database can be selectively granted and/or restricted using an employee authentication credential.

In various implementations, the correspondence generation means comprises a printer, an email plant, or an automated phone system.

In various implementations, the first identifying characteristic comprises a type of correspondence or a communication form.

In various implementations, the first secret code is unique to the first account holder or is unique to the first identifying characteristic. Also, the first identifying characteristic can be different than the second identifying characteristic, such that the first secret code is different than the second secret code.

In various implementations, the correspondence generation means is further for generating a third correspondence to be sent from the financial institution to the first account holder, where the third correspondence comprises a third secret code that signifies a third identifying characteristic of the third correspondence, where the third identifying characteristic is the same as the first identifying characteristic, such that the first secret code is the same as the third secret code, and where the second secret code is different than the third secret code.

In various implementations, the first secret code is reproduced on all correspondence sent from the financial institution to the first account holder comprising the first identifying characteristic.

In various implementations, the first secret code comprises a first portion selectively-generated by the financial institution; and a second portion selectively-generated by the first account holder. In various implementations, the first and/or second secret code comprises alphanumeric characters, a QR code, or a NFC tag.

In another general aspect, the correspondence generation means is for generating a first correspondence to be received by a first account holder, where the first correspondence comprises a first secret code, the first secret code signifies a first identifying characteristic of the first correspondence, and the financial institution is configured to authenticate the first correspondence based at least in part on the first secret code received from the first account holder. Additionally, the correspondence generation means is further for generating a second correspondence received by the first account holder, where the second correspondence comprises a second secret code, where the second secret code signifies a second identifying characteristic of the second correspondence, and where the financial institution is configured to authenticate the second correspondence based at least in part on the second secret code received from the first account holder.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A correspondence identity verification system, comprising:
correspondence generation means for generating a first correspondence to be sent from a financial institution to a first account holder, wherein the first correspondence comprises a first secret code, wherein the first secret code signifies a first identifying characteristic of the first correspondence, wherein the financial institution is configured to identify the first correspondence based at least in part on the first secret code received from the first account holder,
wherein the correspondence generation means is further for generating a second correspondence sent from the financial institution to the first account holder, wherein the second correspondence comprises a second secret code, wherein the second secret code signifies a second identifying characteristic of the second correspondence, and wherein the financial institution is configured to identify the second correspondence based at least in part on the second secret code received from the first account holder.

2. The correspondence identity verification system of claim 1, further comprising a code database in communication with the correspondence generation means, wherein the code data base stores the first secret code and the second secret code.

3. The correspondence identity verification system of claim 2, wherein only the financial institution has access to the code database.

4. The correspondence identity verification system of claim 2, wherein access to the database is selectively granted using an employee authentication credential.

5. The correspondence identity verification system of claim 4, wherein access to the database is selectively restricted using the employee authentication credential.

6. The correspondence identity verification system of claim 1, wherein the correspondence generation means comprises a printer.

7. The correspondence identity verification system of claim 1, wherein the correspondence generation means comprises an email plant.

8. The correspondence identity verification system of claim 1, wherein the correspondence generation means comprises an automated phone system.

9. The correspondence identity verification system of claim 1, wherein the first identifying characteristic comprises a type of correspondence.

10. The correspondence identity verification system of claim 1, wherein the first identifying characteristic comprises a communication form.

11. The correspondence identity verification system of claim 1, wherein the first secret code is unique to the first account holder.

12. The correspondence identity verification system of claim 1, wherein the first secret code is unique to the first identifying characteristic.

13. The correspondence identity verification system of claim 1, wherein the first identifying characteristic is different than the second identifying characteristic, and wherein the first secret code is different than the second secret code.

14. The correspondence identity verification system of claim 13, wherein the correspondence generation means is further for generating a third correspondence to be sent from the financial institution to the first account holder, wherein the third correspondence comprises a third secret code, wherein the third secret code signifies a third identifying characteristic of the third correspondence, wherein the third identifying characteristic is the same as the first identifying characteristic, wherein the first secret code is the same as the third secret code, and wherein the second secret code is different than the third secret code.

15. The correspondence identity verification system of claim 1, wherein the first secret code is reproduced on all correspondence sent from the financial institution to the first account holder comprising the first identifying characteristic.

16. The correspondence identity verification system of claim 1, wherein the first secret code comprises:
a first portion selectively-generated by the financial institution; and
a second portion selectively-generated by the first account holder.

17. The correspondence identity verification system of claim 1, wherein the first secret code comprises alphanumeric characters.

18. The correspondence identity verification system of claim 1, wherein the first secret code comprises a QR code.

19. The correspondence identity verification system of claim 1, wherein the first secret code comprises a NFC tag.

20. A method comprising:
generating, by a financial institution, a first correspondence using a correspondence generation means of the financial institution, wherein the correspondence generation means generates a first secret code based at least in part on a first characteristic of the first correspondence, and wherein the first secret code is included in the first correspondence;
storing the first secret code in a code database of the financial institution, such that the code database associates the first correspondence to the first secret code;
transmitting the first correspondence to a first account holder of the financial institution;
after transmitting the first correspondence, receiving, by the financial institution, a first inquiry from the first account holder regarding the first correspondence, wherein receiving the first inquiry comprises receiving, by the financial institution, as part of the first inquiry, the first secret code included in the first correspondence from the first account holder; and
after receiving the first secret code from the first account holder, looking up, by the financial institution, the first secret code in the code database to identify the first correspondence associated with the first secret code.

21. The method of claim 20, further comprising:
receiving, by the financial institution, a second inquiry from the first account holder, wherein the second inquiry is based on a second correspondence received by the first account holder; and
determining, by the financial institution, that the second correspondence was not transmitted by the financial institution to the first account holder based at least in part on the first account holder failing to locate a secret code in the second correspondence.

22. The method of claim 20, further comprising:
receiving, by the financial institution, a second inquiry from a second account holder, wherein receiving the second inquiry comprises receiving a possible secret code from the first account holder from a second correspondence received by the first account holder; and
determining, by the financial institution, based at least in part on an unsuccessful lookup attempt of the second secret in the code database, that the second correspondence was not transmitted to the first account holder by the financial institution.

23. A correspondence identity verification system, comprising:
correspondence generation means for generating a first correspondence to be received by a first account holder, wherein the first correspondence comprises a first secret code, wherein the first secret code signifies a first identifying characteristic of the first correspondence, wherein a financial institution is configured to authenticate the first correspondence based at least in part on the first secret code received from the first account holder,
wherein the correspondence generation means is further for generating a second correspondence received by the first account holder, wherein the second correspondence comprises a second secret code, wherein the second secret code signifies a second identifying characteristic of the second correspondence, and wherein the financial institution is configured to authenticate the second correspondence based at least in part on the second secret code received from the first account holder.
